(19) United States
(12) Patent Application Publication
(10) Pub. No.: US 2002/0050388 A1
(43) Pub. Date: May 2, 2002

(54) Full compression coaxial cable assembly

(76) Inventor: Jeffrey S. Simpson, Mechanicsburg, PA (US)

Correspondence Address: Steven H. Meyer, Esq., WOODCOCK WASHBURN KURTZ MACKIEWICZ & NORRIS LLP, One Liberty Place - 46th Floor, Philadelphia, PA, 19103, US

(21) Appl. No.: 09/918,041

(22) Filed: Jul. 30, 2001

Related U.S. Application Data
(60) Provisional application No. 60/244,222, filed on Oct. 30, 2000.

(51) Int. Cl. H01R 9/00

(52) U.S. Cl. 174/88 C

(57) ABSTRACT

In a compression coaxial cable assembly, a housing has a contacting face and a coaxial cable has an end inserted into the housing, a signal conductor, and an outer shield. First and second members are mounted to and electrically coupled to the signal conductor and the outer shield, respectively, and each of the first and second members has a deflectable portion projecting from the housing at the contacting face. Upon coupling the housing to a substrate, the deflectable portions each electrically contact corresponding surfaces on the substrate. Upon urging the housing toward the substrate, the deflectable portions each deflect and withdraw into the housing.

### CROSS-REFERENCE TO RELATED APPLICATION

This application claims the benefit of U.S. Provisional Patent Application No. 60/244,222, filed Oct. 30, 2000, hereby incorporated by reference.

### FIELD OF THE INVENTION

The present invention relates to an assembly for mounting a coaxial cable directly to a circuit substrate. In particular, the present invention relates to such an assembly for mounting one or more coaxial cables directly to a circuit substrate.

### BACKGROUND OF THE INVENTION

Under certain circumstances, it is desirable to bring one or more signals to a printed circuit board or the like by way of a coaxial cable. In many situations, each of the one or more coaxial cables is terminated by an appropriate termination device and is coupled by way of the termination device to a connector mounted to the printed circuit board. However, it is to be appreciated that such connector in particular can introduce unwanted parasitic effects such as resistive, capacitive, and/or inductive effects. Particularly in high-speed applications, and as should be appreciated, such parasitic effects are especially problematic.

A need exists, then for an assembly that allows mounting of a coaxial cable to a printed circuit board or other substrate such that the coaxial cable electrically contacts the circuit board without the need for a connector interposed therebetween. Accordingly, unwanted parasitic effects resulting from the connector are eliminated.

### SUMMARY OF THE INVENTION

The present invention satisfies the aforementioned need by providing a compression coaxial cable assembly for being coupled to a substrate. In the assembly, a housing has a contacting face and a coaxial cable has an end inserted into the housing. The cable also has a signal conductor and an outer shield. First and second members are mounted to and electrically coupled to the signal conductor and the outer shield, respectively, at the end of the cable, and each of the first and second members has a deflectable portion projecting from the housing at the contacting face.

Upon coupling the housing to the substrate, the contacting face of the housing faces toward and contacts the substrate, and the deflectable portions each electrically contact corresponding surfaces on the substrate. Upon urging the housing toward the substrate, the deflectable portions each deflect and withdraw into the housing.

### BRIEF DESCRIPTION OF THE DRAWINGS

The foregoing summary, as well as the following detailed description of preferred embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a perspective view of a full compression coaxial cable assembly in accordance with one embodiment of the present invention, in which a plurality of coaxial cables enter a housing which is to be attached generally directly to a printed circuit board or substrate;

FIG. 2A is a side view of the assembly of FIG. 1;

FIG. 2B is a top view of the assembly of FIG. 1;

FIG. 2C is an enlarged view of a portion of FIG. 2A;

FIG. 2D is an enlarged view of a portion of FIG. 2B;

FIGS. 3A-3D are perspective views of a coaxial cable of FIG. 1, and show steps performed in terminating the end of such cable and elements employed therefor in accordance with one embodiment of the present invention;

FIGS. 4A-4C are perspective views of the elements employed in terminating the end of the cable in FIG. 3 and show a bellows contact (FIG. 4A), an insulator tube (FIG. 4B), and a ground spring/shield (FIG. 4C);

FIG. 4D is a plan view of the ground spring/shield of FIG. 4C as stamped in sheet form;

FIGS. 5A and 5B are broken-away perspective views of the housing of FIG. 1, and show an interior cavity for receiving the terminated cable of FIG. 3D (FIG. 5A) and the terminated cable received within the interior cavity (FIG. 5B);

FIG. 6 is a plan view of a printed circuit board or substrate for having the assembly of FIG. 1 mounted thereto; and

FIGS. 7A and 7B are exploded (FIG. 7A) and unexploded (FIG. 7B) perspective views of the coaxial cable of FIG. 1 terminated in an alternate embodiment of the present invention.

### DETAILED DESCRIPTION OF PREFERRED EMBODIMENTS

Certain terminology may be used in the following description for convenience only and is not considered to be limiting. For example, the words “left”, “right”, “upper”, and “lower” designate directions in the drawings to which reference is made. Likewise, the words “inwardly” and “outwardly” are directions toward and away from, respectively, the geometric center of the referenced object. The terminology includes the words above specifically mentioned, derivatives thereof, and words of similar import.

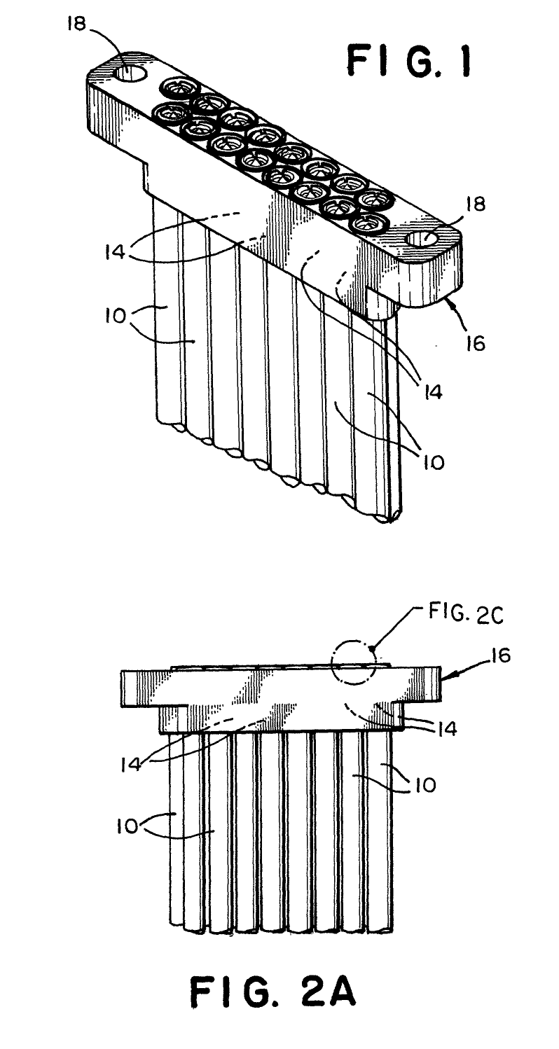

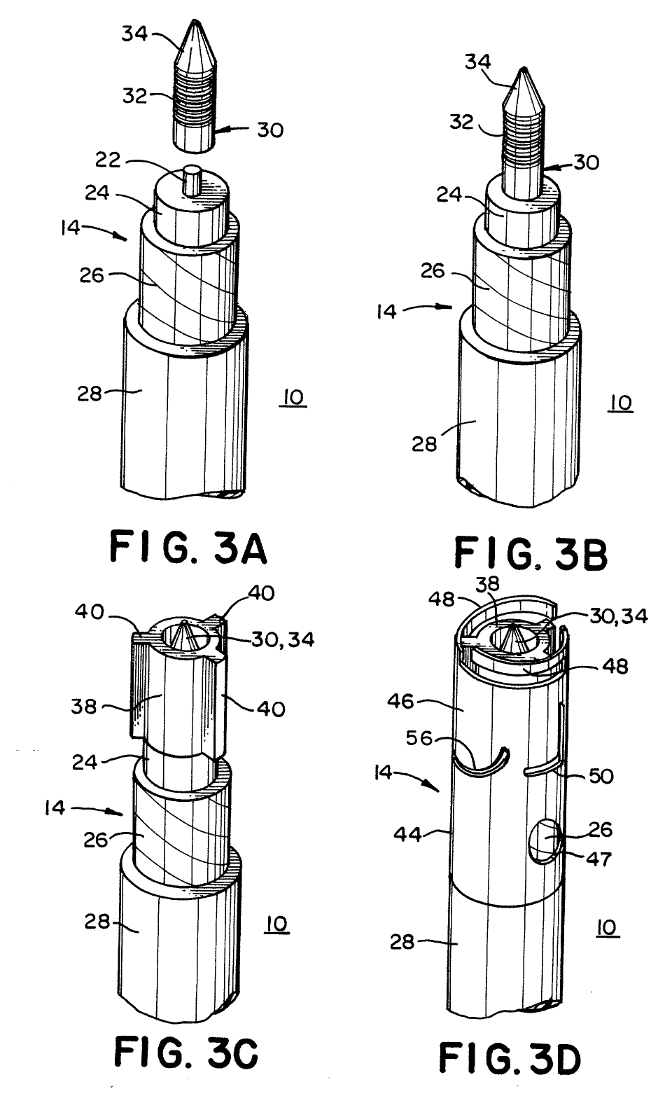

Referring now to FIGS. 1-7B, in the present invention, one or more of coaxial cables 10 are coupled directly to a circuit board or substrate 12 (FIG. 6), where the end 14 of each cable 10 adjacent the circuit board or substrate (hereinafter ‘circuit board’) 12 resides within a housing 16. As discussed in more detail below, the end 14 (FIGS. 3A-3D) of each cable 10 is terminated with components necessary to retain such end 14 within the housing 16 and to ensure good quality compressive contact with the circuit board 12, and such termination components reside substantially within the housing 16 when the cable 10 thereof is mounted to the housing 16. Each of the one or more coaxial cables 10 preferably takes up a minimal amount of space within the housing 16. Accordingly, the housing 16 with the cables 10 mounted thereto imparts a relatively small footprint as mounted to the circuit board 12.

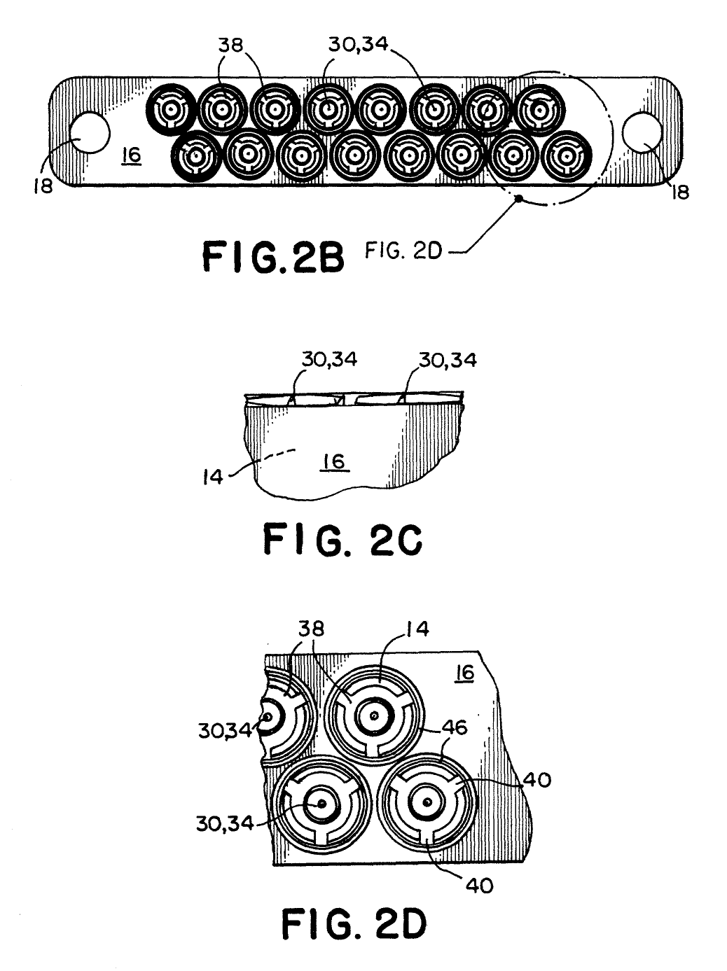

As seen in FIGS. 1 and 2A, in one embodiment of the present invention, one or more of the coaxial cables 10 enter the housing 16 which is to be attached generally directly to the circuit board 12 (FIG. 6). As shown, the cables 10 are arranged in two rows of eight, one row staggered from the other to maximize available space. Of course, any number of cables 10 may be arranged in the housing 16 in any manner without departing from the spirit and scope of the present invention.

The housing 16 may be constructed from a plastic, metal, or other appropriate material by machining, molding, or other appropriate process, all without departing from the spirit and scope of the present invention. Notably, in addition to holding the ends 14 of the cables 10, the housing 16 is constructed and designed to align each end 14 with respect to the circuit board 12 when the housing 16 is mounted to such circuit board 12. As seen, then, the housing 16 may define one or more apertures 18 therein that correspond to apertures 20 within the circuit board 12. Accordingly, upon appropriately aligning the housing 16 with the circuit board 12 such that corresponding ones of the apertures 18, 20 also align, fasteners such as screws or bolts (not shown) may be placed through such aligned apertures 18, 20 to secure the housing 16 to the circuit board 12.

The housing 16 may have one or more keying features (not shown) for ensuring that the housing 16 is properly aligned with respect to and mounted to the circuit board 12. For example, the keying feature may reside in one or more keying studs extend from the housing toward and through the printed circuit board. Such studs may define the apertures 18 of the housing 16, or may be distinct from such apertures 18.

Each cable 10 may be any appropriate type or size of coaxial cable without departing from the spirit and scope of the present invention. As best seen in FIG. 3A, each cable 10 has an inner signal conductor 22 at the center, an insulative dielectric 24 surrounding the signal conductor 22, an outer shield 26 surrounding the dielectric 24, and a non-conductive jacket 28 surrounding the outer shield 26. In the case of a plurality of the cables 10 mounted to the housing 16, the cables 10 may be combined into one or more ribbons or the like, or may be distinct from one another.

As mentioned above, each coaxial cable 10 is provided with termination components at the end 14 thereof to effectuate retention of the end 14 within the housing 16. As will be appreciated, conductive ones of such termination components also directly contact the circuit board 12 to effectuate electrical contact between the circuit board 12 and the cable 10 of such end 14. In one embodiment of the present invention, when the housing 16 is mounted to the circuit board 12, each conductive terminating component extends from the housing 16 toward the circuit board 12 to contact such circuit board 12.

Such conductive termination components are preferably designed to deflect upon such contact, thus ensuring that all such conductive termination components achieve good electrical contact between the respective cables 10 and the circuit board 12. As may be appreciated from FIGS. 2A and 2C, such components deflect at most to the point where the housing 16 as mounted to the circuit board 12 is flush therewith. As may be appreciated, the side of the housing 16 that faces the circuit board 12 as shown in FIGS. 2B and 2D is complementary to the circuit board 12 as shown in FIG. 6 in the region of contact therebetween such that a close contact is achieved. Thus, if the contacting surface of the circuit board 12 is generally planar, then so too is the contacting surface of the side of the housing 16 that faces the circuit board 12 generally planar. As may be appreciated, the housing 16 also protects such components from excess deflection and over-stressing.

Referring to FIG. 3A, now, it is seen that prior to mounting the termination components to the end 14 of a cable 10, such end 14 is stripped of, in decreasing lengths from the face of the end 14 (as best seen in FIG. 2D), the jacket 28, the outer shield 26, and the dielectric 24. Thus, and starting at the face of the end 14, a length of the signal conductor 22 is exposed, a length of the dielectric 24 is exposed, and a length of the outer shield 26 is exposed. As will be appreciated below, the respective lengths are based on and determined in conjunction with dimensions of the terminating components. Such respective lengths may nevertheless be any appropriate lengths without departing from the spirit and scope of the present invention.

In one embodiment of the present invention, once the lengths have been exposed, and as best seen in FIGS. 3A and 3B, a contact 30 is conductively coupled to the signal conductor 22 at the end 14 as one of the termination components. As shown, the contact 30 is fitted over the length of the signal conductor 22 and contacts the dielectric 34 below. Of course, the contact 30 may also be fitted to the signal conductor in any other appropriate manner without departing from the spirit and scope of the present invention. The contact 30 may be appropriately constructed from any appropriate conductive material, may be soldered or brazed to the signal conductor 22, or may be conductively coupled to the signal conductor 22 in another appropriate manner.

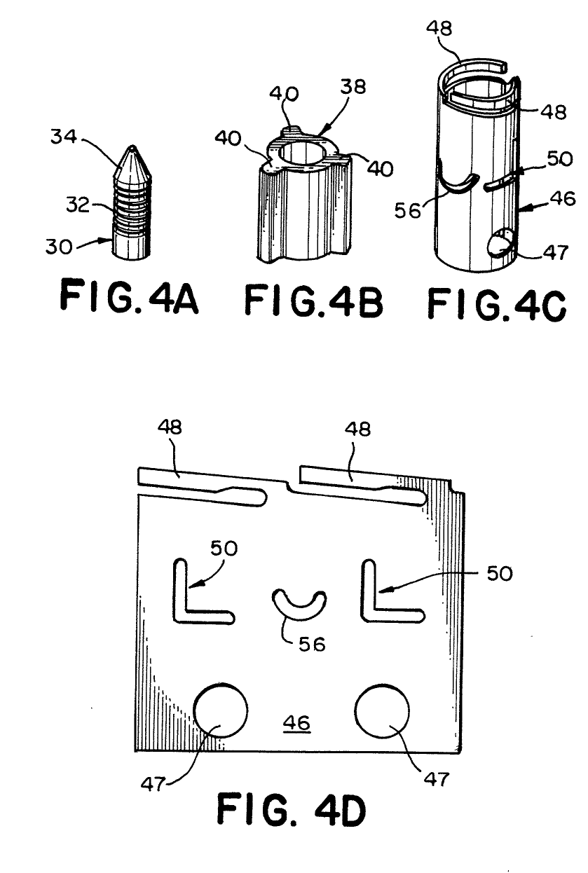

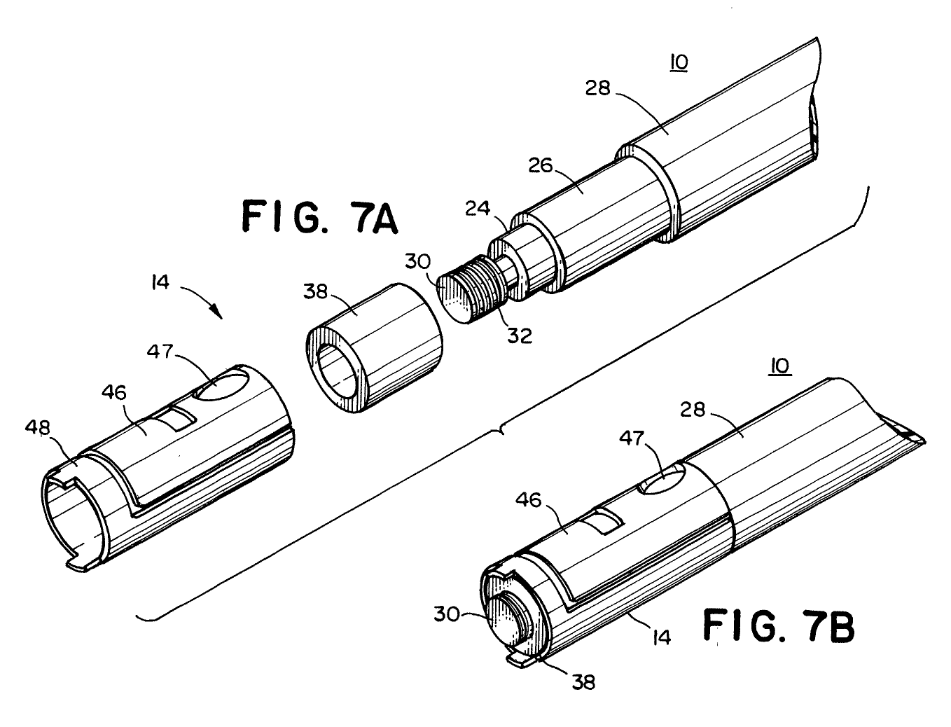

As shown in FIGS. 3A, 3B, and 4A, the contact 30 has a metal deflectable bellows-type portion 32 and has a cone 34 atop the bellows 32 that narrows to a point. As may be appreciated, the point on the cone 34 directly contacts the circuit board 12 at a contact pad 36 thereof (FIG. 6), and the bellows 32 deflects upon contacting the cone 34 to the circuit board 12. As may also be appreciated, the cone 34 with the point is especially useful in that the cone 34 acts as a Hertzian bump that pierces through any dirt, debris or other materials on the corresponding contact pad without the need for any wiping. Such materials are merely pushed aside by such point and a good contact is achieved. Of course, the contact 30 may have any other appropriate deflecting design without departing from the spirit and scope of the present invention. For example, as seen in FIGS. 7A and 7B, the contact 30 may omit the cone 34 if not perceived necessary for a particular application.

With the contact 30 mounted to the signal conductor 22, and as best seen in FIG. 3C, an insulator tube 38 is fitted over the contact 30 so as to contact the dielectric 24 below. As shown, the insulator tube 38 exposes only the point of the cone 34 of the contact 30. Of course, the insulator tube 38 may also be fitted over the contact 30 in any other appropriate manner without departing from the spirit and scope of the present invention. The insulator tube 38 may be held in place by way of an interference fit, by way of a cement or epoxy or the like, or may be coupled in another appropriate manner.

As should be appreciated, the insulator tube 38 is akin to the dielectric 24 and therefore isolates the contact 30 from elements radially exterior thereto. Critically, such tube 38 is sized and formed from a material such that the impedance of the termination components at the end 14 of the coaxial cable 10 matches the impedance of the coaxial cable 10.

In one embodiment of the present invention, and as seen in FIGS. 3C and 4B, the tube 38 is designed with a plurality of generally axially extending ribs 40. As may be appreciated, the ribs 40, three of which are shown, function to space the contact 30 from elements radially exterior thereto, and also function to assist in defining the impedance of the termination components at the end 14 of the coaxial cable 10. Of course, any appropriate material and design for the tube 38 may be employed without departing from the spirit and scope of the present invention. For example, as seen in FIGS. 7A and 7B, the tube 38 may omit the ribs 40 if not perceived necessary for a particular application. Also, any appropriate method of forming the tube 38, such as, molding, extruding, or machining, may be employed without departing from the spirit and scope of the present invention.

As may be appreciated, upon the point on the cone 34 directly contacting the circuit board 12 at a contact pad 36 thereof (FIG. 6), the tube 38 may also contact the circuit board 12, although generally at or in the neighborhood of a buffer 42 surrounding the contact pad 36. Note that absence of such contact between such tube 38 and the circuit board 12 may occur without departing from the spirit and scope of the present invention. As may be appreciated, the buffer 42 acts to isolate the contact pad 36 from conductive elements on the surface of the circuit board exterior to the buffer 42. Such conductive elements may include a ground plane 44, as shown. If contact between the tube 38 and circuit board 12 does occur, the tube 38 preferably deflects upon contacting the circuit board 12.

With the tube 30 fitted over the contact 30, and as best seen in FIG. 3D, a ground spring/shield (hereinafter spring shield) 46 is fitted over the tube 30 so as to conductively contact the outer shield 26 of the cable 10 and to contact the jacket 28 below. As shown, the spring shield 46 substantially covers the length of the tube 38 and exposes only the point of the cone 34 of the contact 30. Of course, the spring shield 46 may also be fitted over the contact 30 in any other appropriate manner without departing from the spirit and scope of the present invention. The spring shield 46 may be held in place by way of an interference fit, by way of being soldered or brazed to the outer shield 26, or may be conductively coupled to the outer shield 26 in another appropriate manner. If solder is employed, such solder may be applied by way of a through-hole 47 in the spring shield 46 (FIG. 4D) to secure the spring shield 46 to the outer shield 26 and thus to the coaxial cable 10.

As should be appreciated, the spring shield 46 is akin to the outer shield 26 and therefore conductively couples the outer shield 26 to the circuit board 12. Thus, upon the point on the cone 34 directly contacting the circuit board 12 at a contact pad 36 thereof (FIG. 6), the spring shield 46 also contacts the circuit board 12, although at a region outside the buffer 42, such as at the ground plane 44.

In one embodiment of the present invention, and as seen in FIGS. 3D, 4C, and 4D, the spring shield 46 includes one or more spring arms 48 that directly contact the circuit board 12 such as at the ground plane 44 thereof (FIG. 6), and that deflects upon contacting the spring shield 46 to the circuit board 12. Of course, the spring shield 46 may have any other appropriate deflecting design without departing from the spirit and scope of the present invention. For example, as seen in FIGS. 7A and 7B, the spring shield 46 may have a different style of spring arm 48. As may be appreciated, each spring arm 48 of the spring shield 46 and the bellows portion 32 of the contact 30 in combination provide a linear normal force between the cable 10 and the circuit board 12. Such linear normal force prevents the spring shield 46 and the contact 30 of each cable 10 from becoming overstressed.

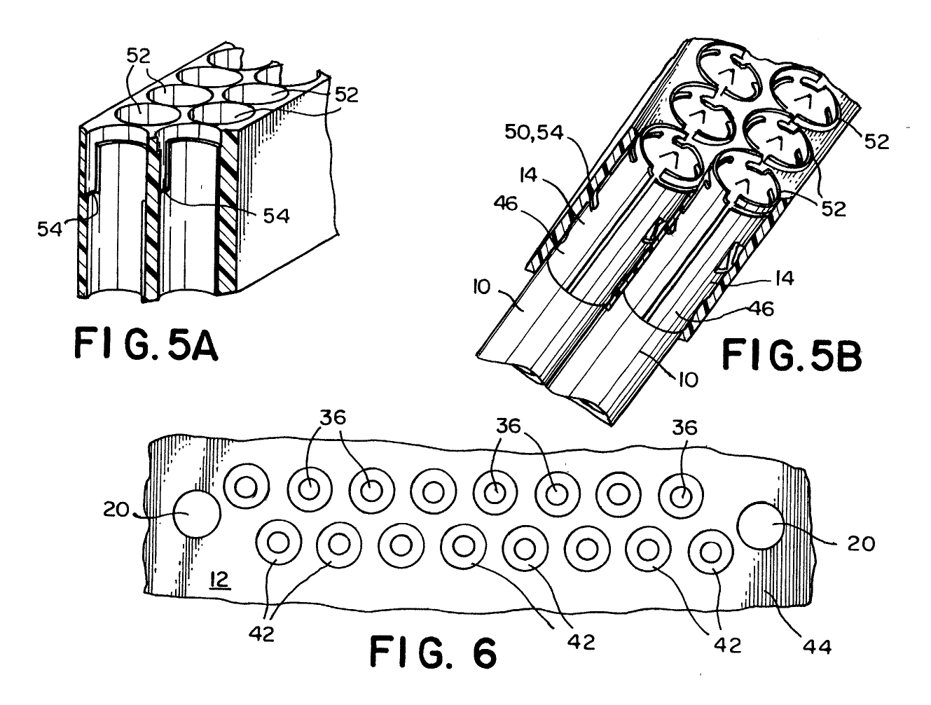

In one embodiment of the present invention, the spring shield 46 includes a retention feature 50 as seen in FIGS. 3D, 4C, and 4D, the housing 16 defines a cable-receiving cavity 52 for receiving the end 14 of each cable 10 mounted thereto as seen in FIGS. 5A and 5B, and the housing 16 further defines a ledge 54 associated with and adjacent to each cavity 52 as also seen in FIGS. 5A and 5B. The retention feature 50 of the spring shield 46 includes a slot defined within the spring shield 46, and an edge of the spring shield 46. As best shown in FIG. 4D, such slot is generally L-shaped, and such edge is just above the horizontal portion of the slot.

As may be appreciated, the retention feature 50 of the spring shield 46 co-acts with the ledge 54 of the cavity 52 to secure spring shield 46 and attached cable 10 within the housing 16. More particularly, the cable 10 with termination components thereon is inserted into the housing 16 from the side of the housing opposite the side that faces toward the circuit board 12 such that the edge of the retention feature 50 of the spring shield 46 springs radially outwardly after passing by the ledge 54 of the cavity 52, thus preventing withdrawal of the inserted cable 10 unless the cable 10 is rotated within the cavity 52 to disassociate the edge from the ledge 54.

Notably, upon inserting the cable 10 into a cavity 52 of the housing 16 and securing the cable 10 to such housing 16 by way of the associated ledge 54, the end 14 of the cable as defined by the termination components protrudes through the side of the housing that faces toward the circuit board 12, as best seen in FIGS. 2A-2D. As shown, the length of such protrusion need not be very much, perhaps on the order of a millimeter or two.

In one embodiment of the present invention, the spring shield 46 includes an impedance tuning feature 56 as seen in FIGS. 3D, 4C, and 4D, the housing 16. As seen, such tuning feature 56 includes a slot defined within the spring shield 46, and a tab associated with the slot. As best shown in FIG. 4D, such slot is generally U-shaped, and such tab is generally defined by the slot. As may be appreciated, the tab of the impedance tuning feature 56 may be manipulated to fine-tune the impedance of the end 14 of the coaxial cable 10 so as to match the impedance of the remainder of the coaxial cable 10. Such manipulation may be performed automatically or manually, before or after inserting the cable 10 within the housing 16. Of course, if performed after insertion, the cable 10 is withdrawn from the housing to provide access to the tuning feature 56.

In one embodiment of the present invention, the spring shield 46 is stamped out of sheet metal or the like in a relatively flat state, as shown in FIG. 4D, and is rolled to its final form. Of course, any appropriate material and method of formation of the spring shield 46 may be employed without departing from the spirit and scope of the present invention. More generally, any appropriate design for the spring shield 46 may be employed without departing from the spirit and scope of the present invention.

In the present invention, upon inserting each cable 10 into a cavity 52 of the housing 16 such that the cable 10 is locked to the housing 16 and protrudes at the side of the housing 16 facing the circuit board 12, the housing 10 may then be appropriately positioned with respect to the circuit board 12 and secured to such circuit board 12. Thus, the contact 30 of each cable 10 in the housing 16 directly conductively contacts a respective contact pad 36 of the circuit board 12 and the spring shield 46 of each cable 10 in the housing 16 directly conductively contacts the ground plane 44. Upon securing the housing 16 to the circuit board 12, the contacts 30 and spring shields 46 each deflect to exert a force normal to the circuit board 12. Upon tightening the housing 16 down to the circuit board 12, the deflecting components essentially disappear within the housing 16, but yet continue to respectively contact the circuit board 12 at the aforementioned points.

In the foregoing description, it can be seen that the present invention comprises a new and useful full compression coaxial cable module for being mounted normally and directly to a printed circuit board 12 or the like and for electrically contacting coaxial cables 10 mounted to a housing 16 of the module to the printed circuit board 12. It should be appreciated by those skilled in the art that changes could be made to the embodiments described above and shown in the drawings without departing from the inventive concept thereof. It is understood, therefore, that this invention is not limited to the particular embodiments disclosed, but it is intended to cover modifications within the spirit and scope of the present invention as defined by the appended claims.

1. A compression coaxial cable assembly for being coupled to a substrate, the assembly comprising:
a housing having a contacting face;
a coaxial cable having an end inserted into the housing, the cable also having a signal conductor and an outer shield; and
first and second members mounted to and electrically coupled to the signal conductor and the outer shield, respectively, at the end of the cable, each of the first and second members having a deflectable portion projecting from the housing at the contacting face;
wherein upon coupling the housing to the substrate such that the contacting face of the housing faces toward and contacts the substrate, the deflectable portions each electrically contact corresponding surfaces on the substrate, and wherein upon urging the housing toward the substrate, the deflectable portions each deflect and withdraw into the housing.

2. The assembly of claim 1 wherein the housing defines at least one aperture corresponding to an aperture within the substrate, whereby such apertures may be aligned and a fastener may be placed through such aligned apertures to urge the housing toward the substrate and secure the housing to the substrate.

3. The assembly of claim 1 wherein upon urging the housing toward the substrate, the deflectable portions each deflect and withdraw into the housing until the housing as mounted to the substrate is flush therewith.

4. The assembly of claim 1 wherein the end of the cable is stripped of, in decreasing lengths from a face of the end, a jacket, the outer shield, and the dielectric to expose a length of the signal conductor, a length of the dielectric, and a length of the outer shield.

5. The assembly of claim 1 wherein the first member is a contact conductively coupled to the signal conductor.

6. The assembly of claim 5 wherein the contact is fitted over and conductively contacts a length of the signal conductor and has a deflectable bellows for deflecting upon the contact contacting the substrate.

7. The assembly of claim 5 wherein the contact has a cone for contacting a contact pad on the substrate, the cone acting as a Hertzian bump for piercing through any dirt, debris or other materials on the contact pad.

8. The assembly of claim 5 wherein the coaxial cable further has an insulative dielectric interposed between the center conductor and the outer shield, the assembly further comprising a third member at the end of the cable corresponding to the insulative dielectric and interposed between the contact and second member.

9. The assembly of claim 8 wherein the third member is an insulator tube fitted over the contact.

10. The assembly of claim 9 wherein the insulator tube is sized and formed from a material such that an impedance of the contact, insulator tube, and second member at the end of the coaxial cable matches an impedance of the coaxial cable.

11. The assembly of claim 10 wherein the tube includes a plurality of generally axially extending ribs which function to radially space the contact from the second member and to assist in defining the impedance of the contact, insulator tube, and second member at the end of the coaxial cable.

12. The assembly of claim 1 wherein the second member is a spring shield fitted over and conductively contacting a length of the outer shield.

13. The assembly of claim 12 wherein the spring shield defines a through-hole through which solder is applied to secure the spring shield to the outer shield.

14. The assembly of claim 12 wherein the spring shield includes at least one deflectable spring arm for directly contacting the substrate and deflecting upon contacting the substrate.

15. The assembly of claim 12 wherein the spring shield includes a retention feature, the housing defines a cable-receiving cavity for receiving the end of the cable mounted thereto, and the housing further defines a ledge associated with and adjacent to the cavity, the retention feature of the spring shield co-acting with the ledge of the cavity to secure the spring shield and cable within the housing.

16. The assembly of claim 15 wherein the retention feature of the spring shield includes a slot defined within the spring shield and an edge of the spring shield adjacent the slot, the edge co-acting with the ledge.

17. The assembly of claim 12 wherein the spring shield includes an impedance tuning feature comprising a slot defined within the spring shield and a tab associated with the slot, the tab being manipulated to fine-tune an impedance of the first member and spring shield at the end of the coaxial cable.

18. The assembly of claim 12 wherein the spring shield is stamped out of a sheet in a relatively flat state and is rolled to a final form.

19. A compression coaxial cable for being coupled to a substrate, the cable having an end for being inserted into a housing having a contacting face, the cable also having a signal conductor and an outer shield, the cable further having first and second members mounted to and electrically coupled to the signal conductor and the outer shield, respectively, at the end of the cable, each of the first and second members having a deflectable portion for projecting from the housing at the contacting face, wherein upon coupling the housing to the substrate such that the contacting face of the housing faces toward and contacts the substrate, the deflectable portions each electrically contact corresponding surfaces on the substrate, and wherein upon urging the housing toward the substrate, the deflectable portions each deflect and withdraw into the housing.

20. The cable of claim 19 wherein the end of the cable is stripped of, in decreasing lengths from a face of the end, a jacket, the outer shield, and the dielectric to expose a length of the signal conductor, a length of the dielectric, and a length of the outer shield.

21. The cable of claim 19 wherein the first member is a contact conductively coupled to the signal conductor.

22. The cable of claim 21 wherein the contact is fitted over and conductively contacting a length of the signal conductor and has a deflectable bellows for deflecting upon the contact contacting the substrate.

23. The cable of claim 21 wherein the contact has a cone for contacting a contact pad on the substrate, the cone acting as a Hertzian bump for piercing through any dirt, debris or other materials on the contact pad.

24. The cable of claim 21 wherein the coaxial cable further has an insulative dielectric interposed between the center conductor and the outer shield, the cable further having a third member at the end of the cable corresponding to the insulative dielectric and interposed between the contact and second member.

25. The cable of claim 24 wherein the third member is an insulator tube fitted over the contact.

26. The cable of claim 25 wherein the insulator tube is sized and formed from a material such that an impedance of the contact, insulator tube, and second member at the end of the coaxial cable matches an impedance of the coaxial cable.

27. The cable of claim 26 wherein the tube includes a plurality of generally axially extending ribs which function to radially space the contact from the second member and to assist in defining the impedance of the contact, insulator tube, and second member at the end of the coaxial cable.

28. The cable of claim 19 wherein the second member is a spring shield fitted over and conductively contacting a length of the outer shield.

29. The cable of claim 28 wherein the spring shield defines a through-hole through which solder is applied to secure the spring shield to the outer shield.

30. The cable of claim 28 wherein the spring shield includes at least one deflectable spring arm for directly contacting the substrate and deflecting upon contacting the substrate.

31. The cable of claim 28 wherein the spring shield includes a retention feature, the housing defines a cable-receiving cavity for receiving the end of the cable mounted thereto, and the housing further defines a ledge associated with and adjacent to the cavity, the retention feature of the spring shield for co-acting with the ledge of the cavity to secure the spring shield and cable within the housing.

32. The cable of claim 31 wherein the retention feature of the spring shield includes a slot defined within the spring shield and an edge of the spring shield adjacent the slot, the edge for co-acting with the ledge.

33. The cable of claim 28 wherein the spring shield includes an impedance tuning feature comprising a slot defined within the spring shield and a tab associated with the slot, the tab being manipulated to fine-tune an impedance of the first member and spring shield at the end of the coaxial cable.

34. The cable of claim 28 wherein the spring shield is stamped out of a sheet in a relatively flat state and is rolled to a final form.
